(19) United States
(12) Patent Application Publication
(10) Pub. No.: US 2006/0211910 A1
(43) Pub. Date: Sep. 21, 2006

(54) MICROPHONE SYSTEM FOR BONE ANCHORED BONE CONDUCTION HEARING AIDS

(76) Inventor: Patrik Westerkull, 436 54 Hovas (SE)

Correspondence Address: FASTH LAW OFFICES (ROLF FASTH), 26 PINECREST PLAZA, SUITE 2, SOUTHERN PINES, NC, 28387-4301, US

(21) Appl. No.: 10/907,059

(22) Filed: Mar. 18, 2005

(51) Int. Cl. H04R 25/00

(52) U.S. Cl. 600/25

(57) ABSTRACT

A bone anchored bone conduction hearing aid system comprising two separate microphones connected to two separate inputs of a hearing aid, and a microphone processing circuit in the electronic unit, processing the signals from the two microphones to increase the sound sensitivity for sound coming from the front compared to sound coming from the rear. One of the sound inlets being the frontal sound inlet which is positioned more in the frontal direction (F) than the other sound inlet. The bone anchored bone conduction hearing aid system of the present invention has a programmable microphone processing circuit where the sensitivity for sound coming from the front compared to sound coming from the rear can be varied by programming the circuit digitally in a programming circuit.

### TECHNICAL FIELD

The present invention relates to a microphone processing system for a bone anchored bone conduction hearing aid.

### BACKGROUND OF THE INVENTION

Bone anchored bone conduction hearing aids are essential for the rehabilitation of patients suffering from some specific type of hearing losses for which traditional hearing aids are insufficient. This type of device consists of an external hearing aid with a vibrating transducer which is connected via a connector to a skin penetrating abutment mounted on a fixture anchored in the skull bone. Alternatively this type of devices may have a vibrator implanted under the skin. Typical for all bone anchored bone conduction hearing aids is that the vibrator of the device is firmly mechanically connected to a fixation somewhere in the skull bone.

A bone anchored bone conduction hearing aid has an electronic circuit for amplifying the signal from the microphone. This electronic circuit may be purely analog or may include digital signal processing. Digital signal processing has been commonly used for hearing aids since around 1997.

Bone anchored bone conduction hearing aids have significant problems with patients experiencing that the sound is mainly picked up from the rear since the device is usually placed behind the ear. Directional microphones has been tried to overcome this problem but these have shown to have other limitations in performance.

Another problem with bone conduction hearing aids is that feedback problems may occur both due to sound radiating out from the skull and going back into the microphone, and due to vibrations that are transmitted from the vibrator to the microphone. Feedback can also Arrangements that have been done to reduce such feedback problems have often had significant limitations in its performance and this limits the output from the device and possibilities for an efficient patient rehabilitation. Bone anchored bone conduction hearing aids have this far been adjusted to the patients individual hearing loss by adjusting potentiometers and switches on the hearing aid manually. Due to the difficulties to properly adjust this manually, the possibilities for an efficient individual fitting of the device has therefore, this far, been lacking. It is important that the hearing aid is properly adjusted according to the individual audiogram of the patient.

Another problem with existing bone anchored bone conduction hearing aids having a skin penetration is the wear and tear on the coupling that connects the hearing aid to the skin penetrating abutment. The existing solutions has a small flexible plastic coupling that goes inside of the abutment and due to the small dimensions and the lack of long term flexibility of the plastics, problems like for example poor sound quality, often occurs with existing bone anchored bone conduction hearing aids.

### SUMMARY OF THE INVENTION

The present invention provides an effective solution to the above-outlined problems with the conventional designs of bone anchored bone conduction hearing aids. The bone anchored bone conduction hearing aid system of the present invention has two separate microphones. Each microphone has a corresponding sound input hole. One of the sound input holes is positioned more frontal than the other sound input hole when the hearing aid is correctly worn by a patient. The frontal direction means the direction that the patient is facing. Preferably the frontal sound input hole is positioned at least 1 mm in front of the rear hole. The microphones may of course be manufactured in one unit as a two-microphone-unit, as long it is still two substantially separated microphones. The present invention has a microphone processing circuit in the electronic unit, processing the signals from the two microphones to increase the sound sensitivity for sound coming from the front compared to sound coming from the rear. With this microphone signal processing circuit the level of and the type of directional sensitivity and frequency response can be optimized for the patients needs. In a preferred embodiment the programmable microphone processing circuit can be digitally programmed. This may be done for example in the manufacturing or in an individual patient fitting procedure. There may be different programs available in the device so that the patient with the aid of a small push button or a remote control can select a suitable program for a specific listening situation. To further improve the flexibility and rehabilitation effect of the hearing aid the programmable circuit may also allow the sound processing parameters of the amplifier to be digitally programmed. Such parameters could for example be gain, compression, noise reduction and other signal processing functions.

In a preferred embodiment the bone anchored bone conduction hearing aid system has an adaptive feedback suppression circuit. The adaptive feedback suppression may be a feedback canceller that calculates the expected feedback signal and subtracts this signal from the processed microphone signal before this signal goes into the amplifier circuit. With this solution the gain of the amplifier is not affected by the feedback suppression circuit.

The feedback suppression circuit may of course be of a more classical type with a notch filter that reduces the amplification at the frequencies where the feedback is most likely to occur. Such a notch filter may be positioned between the microphone and the amplifier or between the amplifier and the vibrator, or it may be integrated into the amplifier circuitry. Such a notch filter may be trimmed in manufacturing or in the fitting procedure but will not necessarily vary in its function when using the hearing aid.

In another preferred embodiment the hearing aid has an adaptive feedback suppression circuit having a gain reducing notch filtering circuit which is automatically controlled by a digital signal processing circuit. This gain reducing notch filtering circuit actively affects the gain of the amplifier.

All of the above mentioned solutions may be built into different types of bone anchored bone conduction hearing aid systems. It may be a system where the vibrator of the hearing aid is positioned outside the skull and where there is a percutaneous abutment that goes through the skin and connects to a fixation in the skull bone. The advantage with such a system is that the hearing aid portion can easily be taken off if it for example needs to be repaired. The above mentioned solutions may also be applied in a bone anchored bone conduction hearing aid system where the vibrator is implanted under the skin and where there are no skin penetration since the signal and the energy to the vibrator is transmitted cordless by for example FM transmission and an inductive link. The vibrator may get power from an external battery via a cordless link or may be powered by an implanted battery. When the implanted battery needs to be charged this could be done via a cordless link transferring energy from an external power source. An advantage with a fully or partially implanted system is that there is no need for a skin penetration.

In a preferred embodiment the present invention the bone anchored bone conduction hearing aid system has a percutaneous abutment and where the coupling that allows the hearing aid to be connected and disconnected from the abutment has a circular spring that presses coupling shoes against the outside of a conical abutment portion so that a circular peripheral portion of the abutment is pressed against the connector plate of the coupling. The coupling shoes is mounted on the connector plate and can mainly be moved only in a plane perpendicular to an axis that goes in the lateral direction. The advantage of this embodiment is that the quality of the coupling will be significantly higher compared to existing solutions. Wear and tear on the coupling of the existing solutions often causes poor sound quality. The present invention can offer significant sound quality and listening advantages compared to the existing solutions.

### BRIEF DESCRIPTION OF THE DRAWINGS

FIG. 1 shows the bone anchored bone conduction hearing aid system with the microphone and electronic circuit and an adaptive feedback cancellation circuit.

FIG. 2 shows the positions of the microphone inlets of the bone anchored bone conduction hearing aid system worn by a patient.

FIG. 3 shows the bone anchored bone conduction hearing aid system with the microphone and electronic circuit with a notch filter positioned between the amplifier and the vibrator of the hearing aid.

FIG. 4 shows the bone anchored bone conduction hearing aid system with the microphone and electronic circuit with an adaptive automatic notch filter that controls the gain of the amplifier.

FIG. 5 shows an example of a bone anchored bone conduction hearing aid system with a skin penetrating abutment and a coupling that allows the hearing aid to be disconnected from the abutment.

FIG. 5 is a cross-sectional side view of the coupling in FIG. 4 when the hearing aid is connected to the abutment.

FIG. 6 shows the same embodiment as FIG. 5 but in a position where the hearing aid has been disconnected from the skin penetrating abutment.

FIG. 7 is an exploded perspective view of the components of the coupling and the abutment in FIG. 6.

### DETAILED DESCRIPTION OF A PREFERRED EMBODIMENT

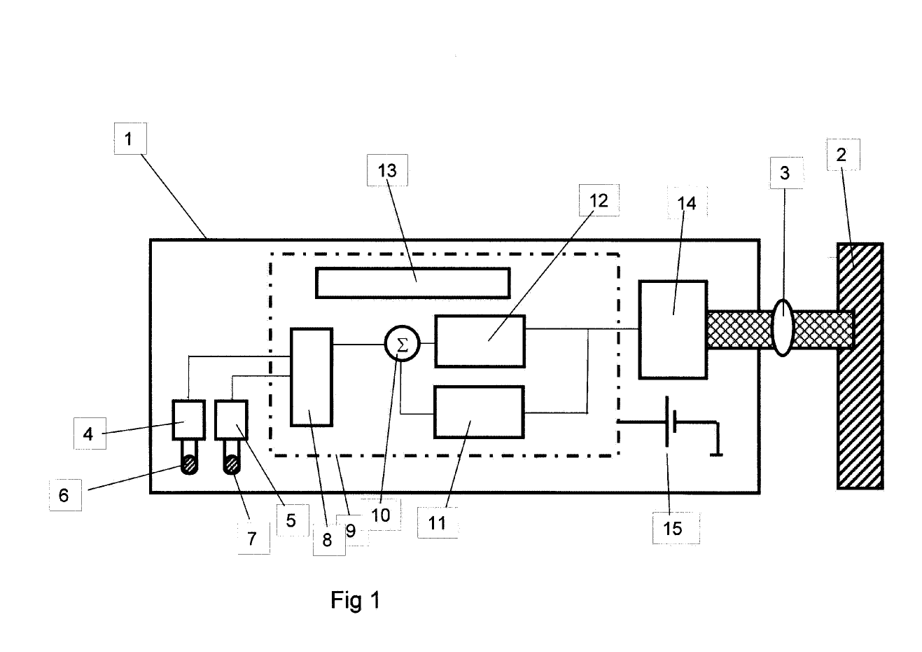

In FIG. 1, a preferred embodiment of a bone anchored bone conduction hearing aid 1 is shown. The hearing aid is connected to the skull bone via a coupling 4. The hearing aid 1 has a front microphone 4 and a rear microphone 5. The front microphone 4 has a corresponding front sound inlet 6 and the rear microphone 5 has a corresponding rear sound inlet 7. The hearing aid has a microphone processing circuit 8 in the electronic module 9. In a summation circuit 10 the signal from the microphone processing circuit 8 is summarized with the signal from an adaptive feedback cancellation circuit 11. The signal then goes into the amplifier 12. The electronic circuit has a programmable circuit 13 where the sound processing parameters and the processing of the microphone processing circuit can be programmed.

The signal from the amplifier 12 goes into the vibrator 14. The electronic circuit is powered by a battery 15.

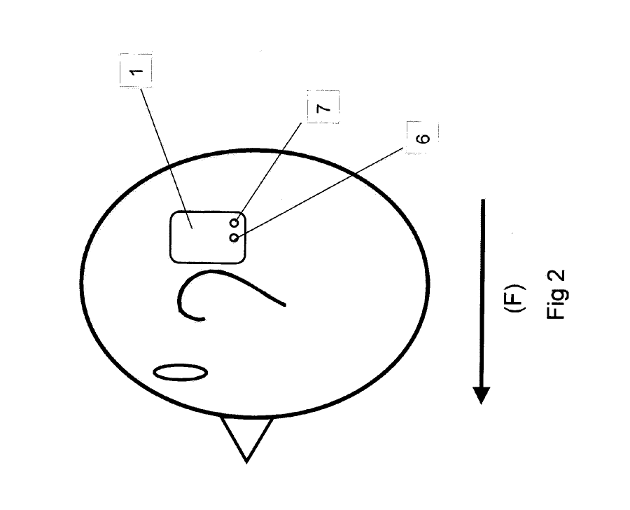

FIG. 2 shows the front sound inlet 6 and the rear sound inlet 7 of the bone anchored bone conduction hearing aid 1. The arrow (F) indicates the front direction.

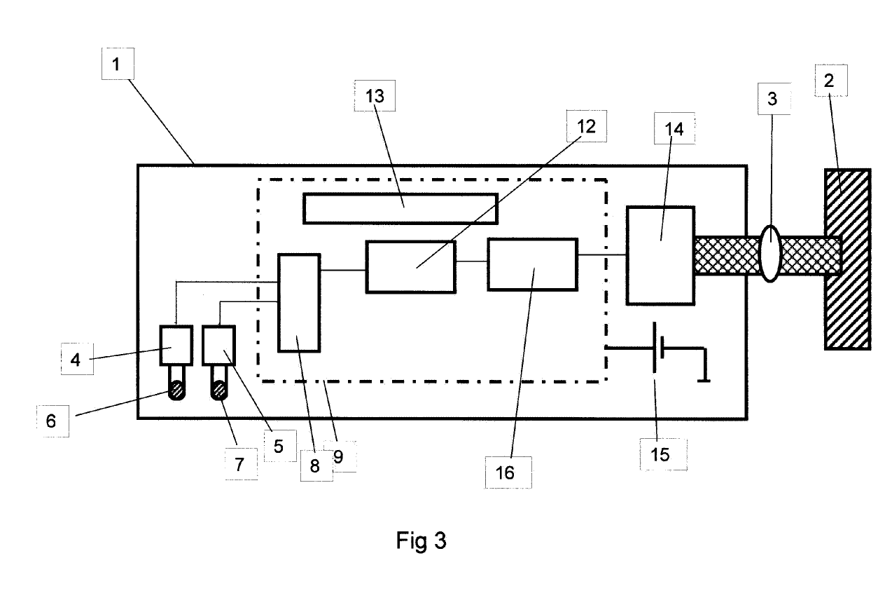

FIG. 3 shows a preferred embodiment of a bone anchored bone conduction hearing aid 1. The hearing aid is connected to the skull bone via a coupling 4. The hearing aid 1 has a front microphone 4 and a rear microphone 5. The front microphone 4 has a corresponding front sound inlet 6 and the rear microphone 5 has a corresponding rear sound inlet 7. The hearing aid has a microphone processing circuit 8 in the electronic module 9. The signal then goes into the amplifier 12. The electronic circuit has a programmable circuit 13 where the sound processing parameters and the processing of the microphone processing circuit can be programmed.

The signal from the amplifier 12 goes into a notch filter circuit 16 before it goes into the vibrator 14. The electronic circuit is powered by a battery 15.

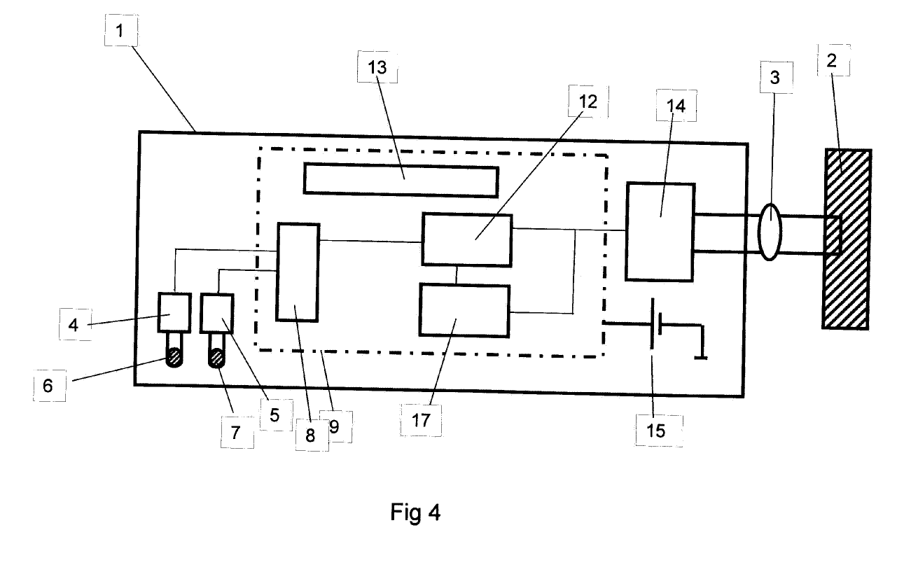

FIG. 4 shows a preferred embodiment of a bone anchored bone conduction hearing aid 1. The hearing aid is connected to the skull bone via a coupling 4. The hearing aid 1 has a front microphone 4 and a rear microphone 5. The front microphone 4 has a corresponding front sound inlet 6 and the rear microphone 5 has a corresponding rear sound inlet 7. The hearing aid has a microphone processing circuit 8 in the electronic module 9. The signal then goes into the amplifier 12. The electronic circuit has a programmable circuit 13 where the sound processing parameters and the processing of the microphone processing circuit can be programmed. The signal from the amplifier 12 goes into the vibrator 14 and into a feedback suppression circuit 17 that controls the gain of the amplifier. The electronic circuit is powered by a battery 15.

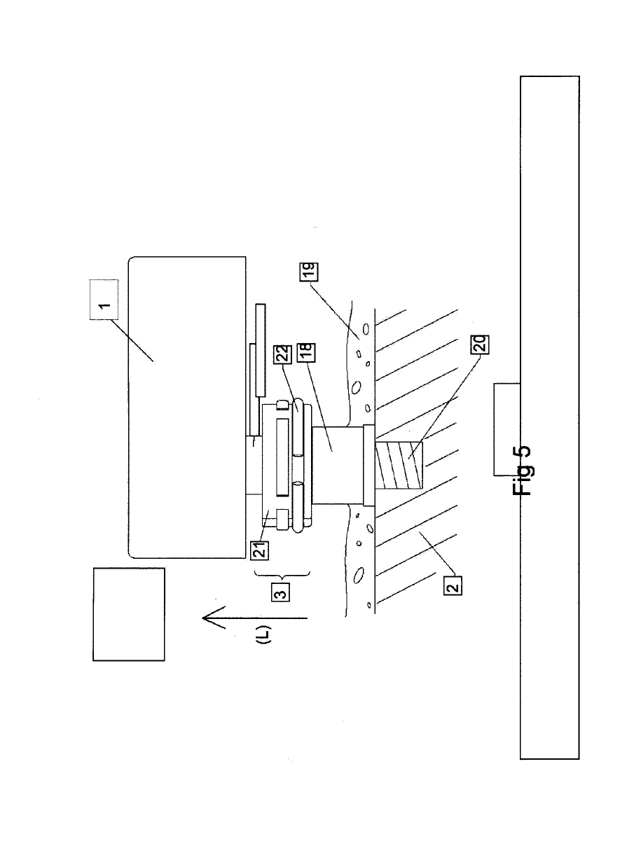

FIG. 5 shows a preferred embodiment of a bone anchored bone conduction hearing aid 1. The hearing aid has a coupling 3 so that the hearing aid can be easily connected and disconnected to a skin penetrating abutment 18 that goes through the skin 19 and that is connected to a fixation 20 in the skull bone 2. The arrow (L) indicates the lateral direction. The coupling 3 has coupling shoes 21 that are pressed against the outside of the abutment 18 by a circular spring member 22. The abutment has a conical portion 23 and a circular peripheral contact surface 24 in its lateral end. The microphones 4 & 5 are positioned in the hearing aid and can not be seen in this figure.

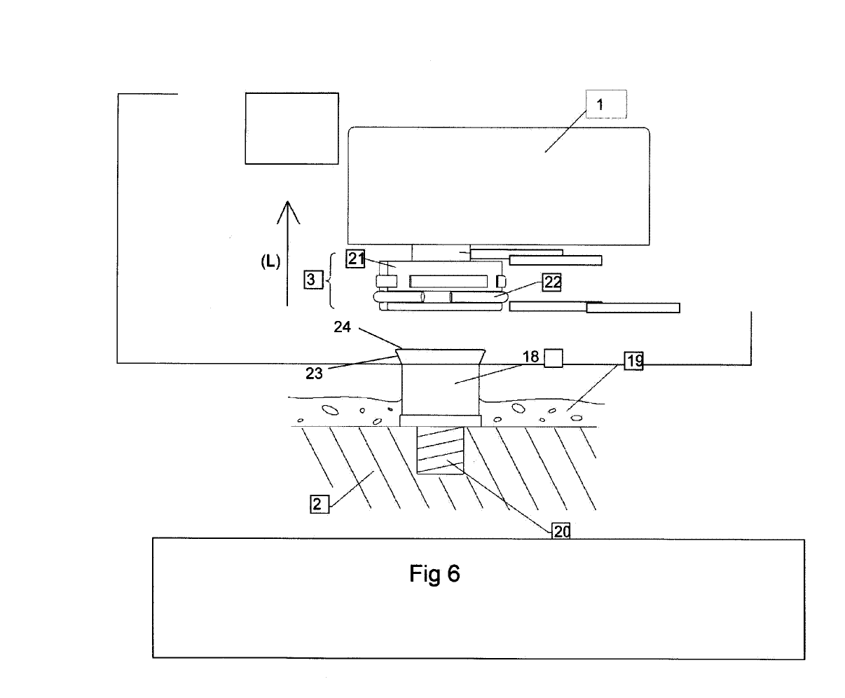

FIG. 6 shows the same embodiment as FIG. 5 but in a position where the hearing aid 1 has been disconnected from the skin penetrating abutment 18.

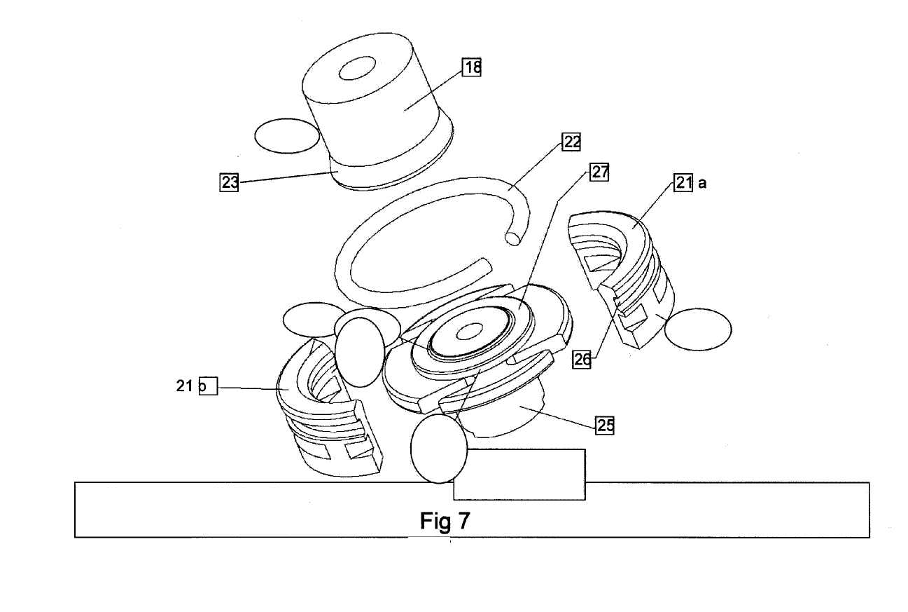

FIG. 7 is an exploded perspective view of the components of the coupling and the abutment in FIG. 6. The coupling shoes 21a and 21b can be mounted on the connector plate 25 and the spring 22 can be mounted in the groove 26 on the outside of the coupling shoes 21a and 21b. When the spring 22 and the coupling shoes 21a and 21b are mounted on the connector plate 25 as in FIG. 6, the coupling shoes 21a and 21b are pressed inwards by the spring 22. If the coupling 3 is connected to the abutment 18 as in FIG. 5 the coupling shoes 21a and 21b presses against the conical portion 23 of the abutment 18 which causes the peripheral circular portion 24 of the abutment 18 to be pressed against the circular contact surface 27 of the connector plate 25.

For all of the above embodiments several alternative designs and combinations are possible and the invention is not limited to the preferred embodiments presented above. While the present invention has been described in accordance with preferred compositions and embodiments, it is to be understood that certain substitutions and alterations may be made thereto without departing from the spirit and scope of the following claims.

1. A bone anchored bone conduction hearing aid system comprising:
a fixture attached to a skull bone;
a vibrator firmly attached to the fixture;
two separate microphones connected to two separate inputs of a bone anchored bone conduction hearing aid;
a suspension system disposed between the vibrator and the two microphones;
a microphone processing circuit in the electronic unit processing the signals from the two microphones to increase the sound sensitivity for sound coming from one direction compared to sound coming from another direction;
the system having a first sound inlet and a second sound inlet defined therein corresponding to each of the two microphones; and
the first sound inlet being a frontal sound inlet which is positioned further towards a frontal direction (F) compared to a position of the second sound inlet.

2. The bone anchored bone conduction hearing aid system according to claim 1 wherein the system has a programmable circuit for digitally programming the sound processing parameters of the amplifier.

3. The bone anchored bone conduction hearing aid system according to claim 1 wherein a programmable microphone processing circuit where the sensitivity for sound coming from the front compared to sound coming from the rear is variable by programming the circuit digitally in a programmable circuit.

4. The bone anchored bone conduction hearing aid system according to claim 1 wherein a processed microphone signal goes out from the microphone processing circuit.

5. The bone anchored bone conduction hearing aid system according to claim 4 wherein the adaptive feedback circuit is a feedback canceller that calculates the expected feedback signal and subtracts this signal from the processed microphone signal before this signal goes into the amplifier.

6. The bone anchored bone conduction hearing aid system according to claim 1 wherein a feedback suppression circuit consists of a notch filter that reduces the amplification at the frequencies where the feedback is most likely to occur.

7. The bone anchored bone conduction hearing aid system according to claim 1 wherein an adaptive feedback suppression circuit that is digitally controlling a gain reducing notch filtering function of the amplifier.

8. The bone anchored bone conduction hearing aid system according to claim 1 wherein a coupling connects the hearing aid to a skin penetrating abutment that is connected to a fixation in the skull bone, the system also has a circular spring that presses coupling shoes against the outside of a conical abutment portion so that a circular peripheral portion of the abutment is pressed against a contact surface of the connector plate of the coupling.

9. The bone anchored bone conduction hearing aid system according to claim 1 wherein the vibrator is implanted under the skin and where the energy to the vibrator is transmitted cordless through the skin.

10. The bone anchored bone conduction hearing aid system according to claim 1 wherein the vibrator is implanted under the skin and where the energy to the vibrator can be stored in an implantable battery which is charged by transmitting the energy cordless through the skin.
